(19) United States
(12) Patent Application Publication
(10) Pub. No.: US 2009/0019958 A1
(43) Pub. Date: Jan. 22, 2009

(54) Planetary gyroscopic drive system with transmission

(76) Inventor: Craig Howard Zeyher, Haddonfield, NJ (US)

Correspondence Address: Craig Howard Zeyher, 131 Rhoads Avenue, Haddonfield, NJ, 08033-1414, US

(21) Appl. No.: 12/154,799

(22) Filed: May 28, 2008

Related U.S. Application Data
(60) Provisional application No. 60/961,277, filed on Jul. 20, 2007.

(51) Int. Cl. G01C 19/06

(52) U.S. Cl. 74/5.7

(57) ABSTRACT

This invention relates to the use of transmissions in combination with gyroscopically based drive systems. The advantage of which is the ability to modulate the rotor or gyros rotational rate of spin semi autonomously from the precessional rate and effect a greater transfer of power while doing so. In addition the use of a transmission or transmissions helps create a back force in the gyroscopic system which results in a more effective drive.

### BACKGROUND OF THE INVENTION

With ever increasing world demand upon natural resources especially those relating to energy it becomes imperative not only to find new forms of power generation but to find means by which to economize or efficiently maximize energy producing capabilities. Applicants previous applications U.S. Pat. No. 11/405,172 and PCT application PCT/US2007/001036 dealt with the basic concept of utilizing gyroscopic principals as a driving means or assisting means in generating electric power. The following invention relates to improvements to this basic concept and design and involves use of transmissions in combination with gyroscopically driven power systems resulting in a more efficient, practical and reliable drive system.

### BRIEF SUMMARY OF THE INVENTION

This invention relates to the use of a transmission in combination with a gyroscopic drive system and allows for the effective conversion and leveraging of precessional motion as an integral part of a drive mechanisium. Once started, (as is described later in this summary), a spinning gyro or rotor offset from its original axis of rotation results in both precessional motion and a force acting to restore itself to its original axis of rotation. This restorative force is maintained as long as the offset gyros mass and speed of rotation are maintained. (Gyro and rotor are used interchangeably in the following description).

A housing supports an assembly designed to permit precessional motion consisting of an inner platform on which is mounted a rotor, gyro or generator assembly and which can turn 360 degrees within an outer platform which supports the inner platform and is designed to undulate in response to the forces to be described. Through use of transmissions mounted on the inner platform located along the spinning gyros axle relatively low precessional speed can be converted to high speed rotation or more force-full rotor rotation by virtue of contact between the end of the rotor axle and a relatively stationary track. The inner platform carrying the gyro or generator assembly has extension arms mounted on opposite sides of the inner platform and on opposite ends of the gyro's axle. When these arms are extended they compress spring backed plates (or magnetically backed plates) located above and below the gyro assembly. Theses compressed plates are equipped with weight shifting assemblies helping to skew the plates so as to create a more precessionally directed force in response to there compression (This is achieved through gravity or motor assist). At the same time the extension arms are extended and compressing the spring or magnetically backed plates they are also offsetting the spinning gyros axis of rotation. This results in precessional motion of the offset spinning gyro and a corresponding force acting to restore the gyro to its original axis of rotation. Restrained from restoring itself to its original axis of rotation by virtue of the extension arms the now compressed springs or magnetically backed plates react through the extension arms with the inner platform carrying the gyro or rotor assembly to drive or push the assembly along on its precessional path. By virtue of the end of the gyros axle being in contact with a track located on the relatively stationary outer platform the rotor or gyro is forced to spin in response to being driven along on its precessional path. (This driving force has the additional benefit of resulting in mechanical advantage resulting from “forced precession”).

The spring or magnetically backed plates in this design are continually and automatically repositioned in response to there compression by the restorative and precessing force of the gyro constantly shifting the point of maximum compression and by the driving force of the compressed spring or compressed magnetic fields acting through the extension arms connected to the inner platform to aid in the precessional motion of the precessing assembly. By virtue of the gyros axle contact with a relatively stationary track (geared or otherwise) the axle is forced to turn which results in rotor rotation. Through use of transmissions located along the axle on either sides of the gyro or rotor this relatively slow precessional motion can be converted and leveraged into high speed and/or high power rotor rotation and permits use of a single track on which the gyro axle reacts by reversing the axle rotation on one side of the gyro so that rotor axle movement is not in opposition to itself With the gyro or rotor spinning at a relatively high speed the restorative force of the offset spinning gyro is maintained which maintains the reflective force of the compressed springs (or compressed magnetic field) this in turn maintains rotor and axle rotation in contact with the relatively stationary track. With the spring backed plate (or magnetically backed plate) compressed by the restorative force of the spinning gyro a back force results from the resistance of the transmission driving the rotor in combination with the axle in contact with the track against the compressed spring (or compressed magnetic field when using opposing magnetic fields) of the spring backed plate. This back force is leveraged through use of the transmissions to help maintain rotor rate of spin, create greater driving force against resistance (such as when used in the generation of electric power) and aide in achieving more continuity of drive and energy conservation.

Any additional driving force if needed can be supplied by a motor assist. The result of this arrangement is a drive system of high efficiency.

A motor assist also allows for a more convenient and simplified means for starting the machine. With the rotor (gyro) axle seated in or against a corresponding relatively stationary track mounted on the relatively stationary outer platform use of a motor drive mounted to this platform can be engaged to drive the rotor axle along its corresponding track by virtue of another track mounted to the inner platform until the desired speed is achieved thus eliminating the need for numerous adjustments and the apparatus for doing so.

### BRIEF DESCRIPTION OF THE SEVERAL VIEWS OF THE DRAWINGS

FIG. 1 is a sectional view of a drive mechanisium employing transmissions to implement the above described system of operation.

FIGS. 2A and 2B depict an alternative design using ball bearing races and a motor drive aid.

FIG. 3 is an enlarged front view of the central section of FIG. 1 depicts details of a starting or assisting motor drive aid.

FIG. 4 shows a sectional cross section taken roughly along the cutting plane 4-4 of FIG. 1.

FIG. 5 Depicts a Gyroscope and its torque axis, spin axis and precessional axis.

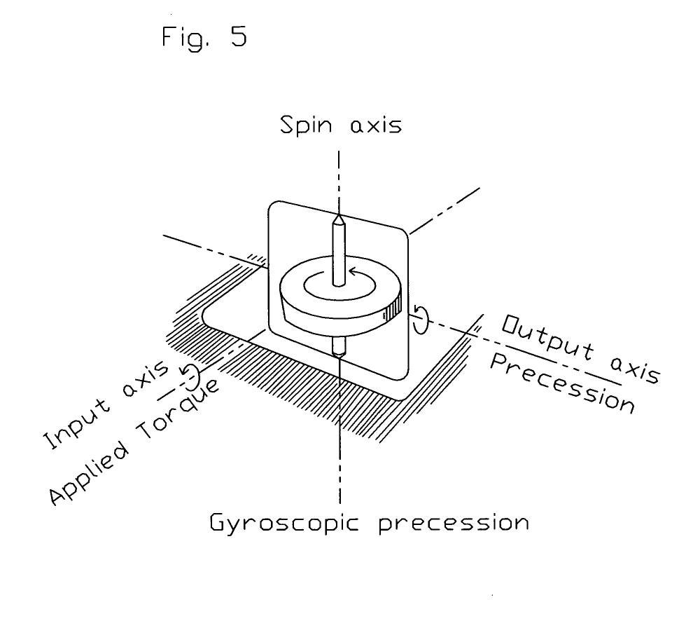

FIG. 6 is an enlarged side view of the central section of FIG. 1.

FIG. 7 Shows the use of a motor drive to insure coordination of the weighted ball assembly (2) with the precessing rotor assembly.

FIG. 8A Is an enlarged view showing details of the weighted ball assembly. FIG. 8B shows the weighted ball assembly with an electric motor aid.

FIG. 9. Is a segmented front view showing the invention utilized as a generator along with stabilizing apparartus and transmission.

FIG. 10. Is a segmented side view showing the invention utilized as a generator along with stabilizing apparatus and transmission.

### DETAILED DESCRIPTION OF THE INVENTION

Following is a detailed description of the means and method by which improvements to a basic gyroscopic drive system are utilized.

By applying a predetermined force of constant duration to the precessing axis of a spinning gyro a sustained rotational force can be produced and maintained with minimal expenditure of energy.

When the axis of rotation of a spinning gyro (or rotor) is offset the gyro (or rotor) precesses and exerts a force acting to restore the rotor to its original axis of rotation. Rotor rotation can be maintained with minimal energy input if this restorative force is opposed by applying an opposite and equal force to the rotor's rotational axis and directing the resultant of these forces to aid the precessional motion of the offset spinning precessing rotor. To maintain this operational mode continuously and automatically I have invented a structural arrangement for achieving this end.

When the spin axis of a rotating body is offset the precessional axis moves in a conical locus and attempts to return to its original position in accordance with gyroscopic principals. I have found that by modulating a force which assists the precessional motion, the rotational speed of the system can be regulated with minimal energy input. This phenomenon in turn can be used as a drive means.

With the rotor offset and exerting a force acting to restore itself to its original position this “restorative” force is opposed by applying a force consisting of two components, an opposing component and a component assisting the rotor's rotation and precessional motion. The opposing component is in direct opposition to the restorative force while the assisting component aids the precessional motion of the offset spinning and precessing rotor. The restorative force is opposed automatically by providing a plate backed by a spring which is compressed by the restorative force. The precessing force is assisted by skewing this plate to produce a resultant force helping to maintain operational speed and precessional motion. This mode of operation for maintaining the rotational speed of the rotor can be achieved in a number of ways such as opposing magnetic fields but in the example at hand this is achieved by a plate backed by a spring which is compressed by the careful and measured extension of the extension arms connected to the inner platform which carries the rotor assembly and by adjustment in the positioning of the spring backed plates.

Simultaneously to opposing the restorative force a component of this same restorative force is used to assist the precessional motion of the offset spinning and precessing rotor by applying a constant moving force delivered to the inner platform behind the spinning rotor axle at a rate which neither overrides nor under rides the precessional motion of the precessing rotor but rather applies a force behind this precessing axle causing the rotor axle to be driven ahead of this constant force. Through use of a track, (geared or otherwise) and axle contact with this track in combination with a transmission the rotor rate of spin in relation to the precessional rate can be modified thus permitting the rotor to spin at a semi-autonomous speed in relationship to the precessional motion of the rotor axle in contact with the track. This allows for a back force to be generated against the reactive spring backed plate (or similar reactive assembly) and rotor speed to be maintained resulting in a more effective drive system

The above described operations are achieved through careful and measured adjustment of pressure exerted upon the plates and springs and by use of two specifically weighted ball bearing type assemblies which are used to position the plate. The resulting torque, rate of spin and precessional speed of the spinning precessing rotor can be monitored through means common to the art, laser timing devices and computer feedback and analysis.

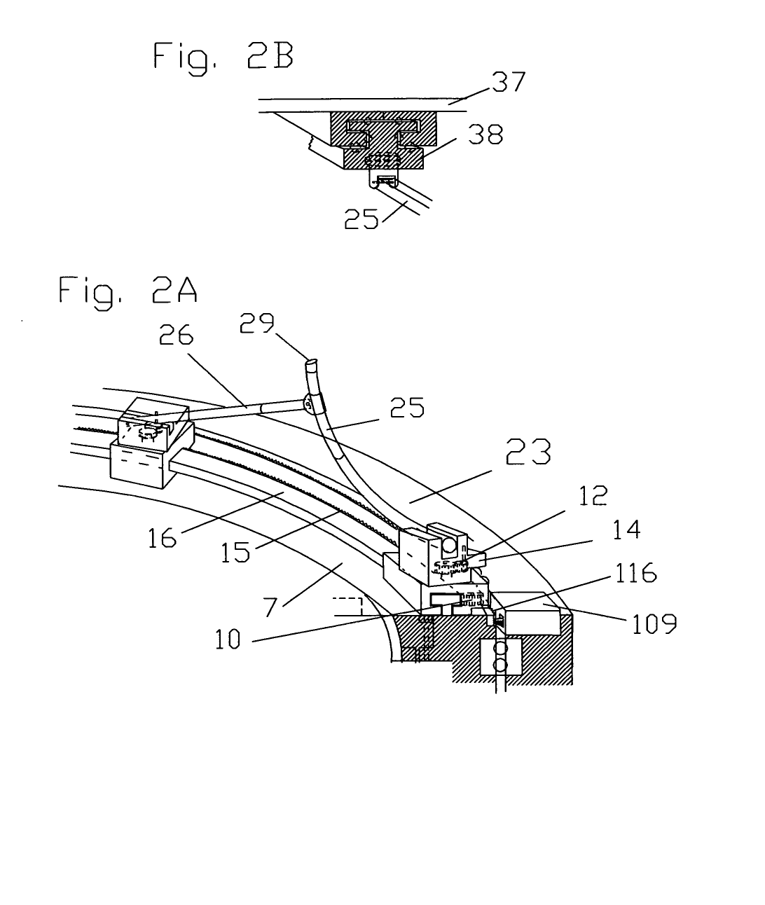

Careful placement and extension of the extension arms is required to attain maximum effective driving force from reaction to the spring backed plates. The extension arms can be curved (best seen in FIG. 2A) where they contact the inner platform track so as to achieve a more direct vectoring of force in assisting the precessional motion of the precessing rotor and inner platform. Precessional motion can also be aided by skewing of the spring backed plate to produce a precessionally directed force component.

With the rotor maintaining its rate of spin the restorative torque force is maintained and this in turn maintains the reactionary force utilized to maintain system operation.

Described and illustrated below are mechanical means for achieving this unique mode of operation. It is to be understood however that this invention is not limited to the precise embodiment or application described.

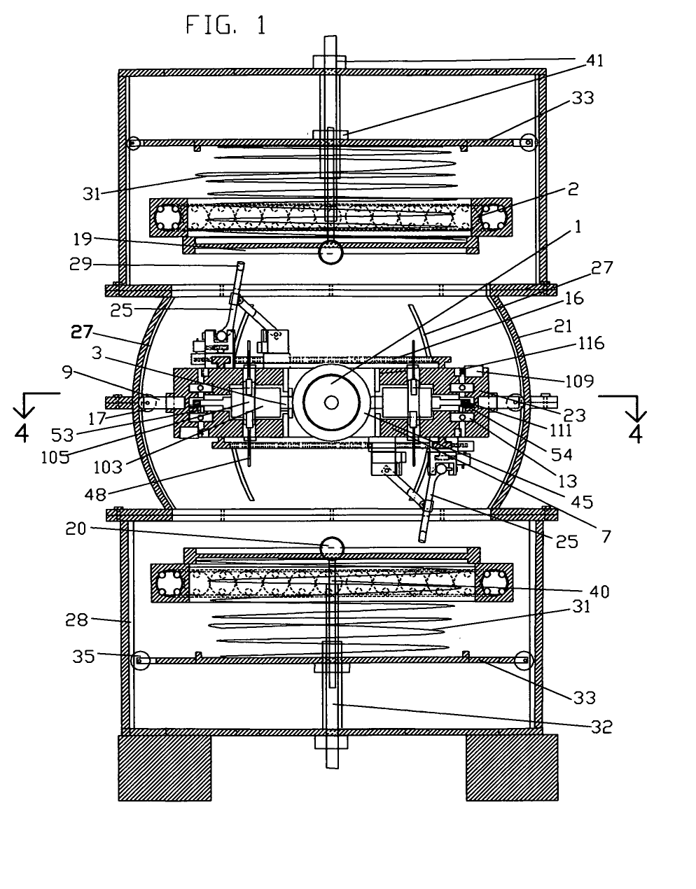

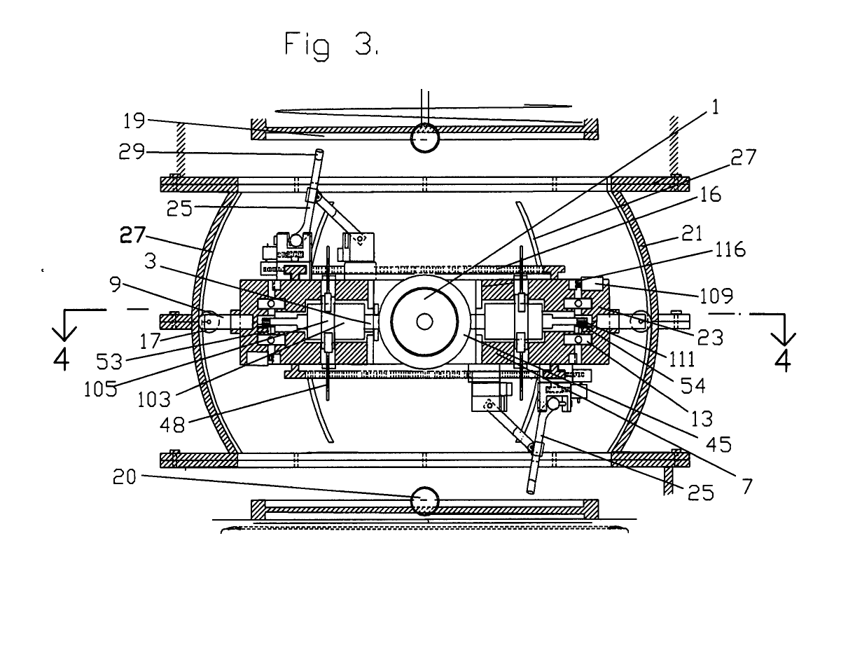

Referring to FIG. 1 there is shown a constant drive mechanism employing gyroscopic principals of operation in combination with a transmission. A sphere or cylinder (1), herein referred to as a rotor is shown for use in a generator assembly (45) and mounted for rotation relative to an outer platform (23) by means of ball bearing assemblies (13) interposed between inner platform (7) and outer platform (23) (best seen in FIG. 3). This arrangement permits rotation of the rotor axle and inner platform (7) in a direction perpendicular to the axis of rotation of the rotor (1) and provides two degrees of freedom in the gyroscopic movement of the assembly. The outer platform (23) is mounted for movement relative to the fixed housing (21) through support arms (9) mounted with ball bearings or wheels (17) having minor pivotal capability which ride in tracks (27) provided in the wall of housing (21). This arrangement permits platform (23) to execute a complex wobbling or undulating motion.

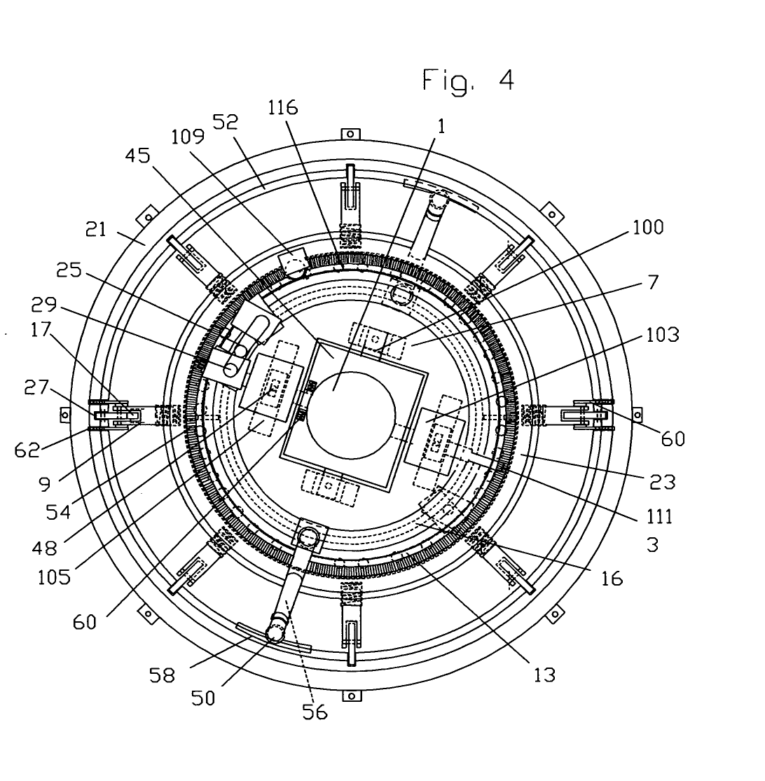

A spinning rotor (1) when subject to a torque tending to change its axis of rotation causes precessional motion of the rotating body and a resulting force acting to restore it to its original position. Modulation of the resulting force can be used to control the rotational speed of the gyro. The preferred mode of operation is to oppose the resulting force (restorative force) by a counter force producing a component of force directed upon the spin axis to assist in the precessional motion of the gyro as it moves along its precessional path. Rotor (1) (best seen in FIGS. 1 and 4) is initially brought up to speed by to engaging a motor drive (109) mounted to the outer platform (23) which engages a track (116) located on the inner platform (7) resulting in the inner platform turning in response. Through gyro (rotor) axle contact with track (54) located on the outer platform the gyro (rotor) is forced to turn and brought up to operating speed. An alternative is to operate the rotor as a motor (by means common to the art) until adequate operating speed is attained where upon power is cut to the rotor and it is operated as a generator.

Motor or Generator components are depicted generically in FIGS. 1, 4, 9 and 10). Once the rotor is brought up to speed platform (23) is tilted through extension of remotely controlled servo operated telescoping extension arms (25) as seen in FIG. 1, equipped with magnetic ends (29). The spring backed plates (19) are magnetic on the inner surface facing the rotor and of similar polarity to the magnetic tipped extension arms so as to repulse each other. A lip can be employed as a precautionary measure, on the edge of the magnetic plate (19) to insure that upon extension of extension arms (25) the two components remain in operational proximity to each other. Extension arms are located on either side of the inner platform (7). One on the upper side and one on the lower side are located so as to achieve tilting of the platform assembly and rotor spin axis while simultaneously compressing the springs (31). Weighted ball bearing type assemblies (2) are used to skew the spring backed plates (19) in a direction to produce a force component assisting precessional motion of the tilted rotor. Regulating the speed of rotation is achieved in a number of ways. Through motor drives (41) extension arms ((32) and (40)) adjustment to plates (33) and (19) can be made both in the spring tension and proximity to the rotor (1) assembly. Another means for rotor speed regulation is through use of or in combination with transmissions.

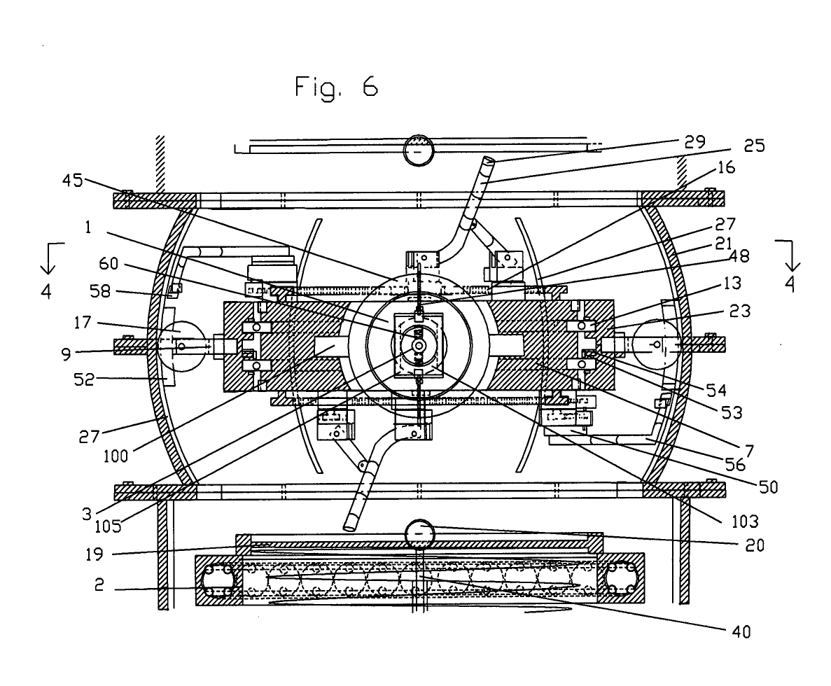

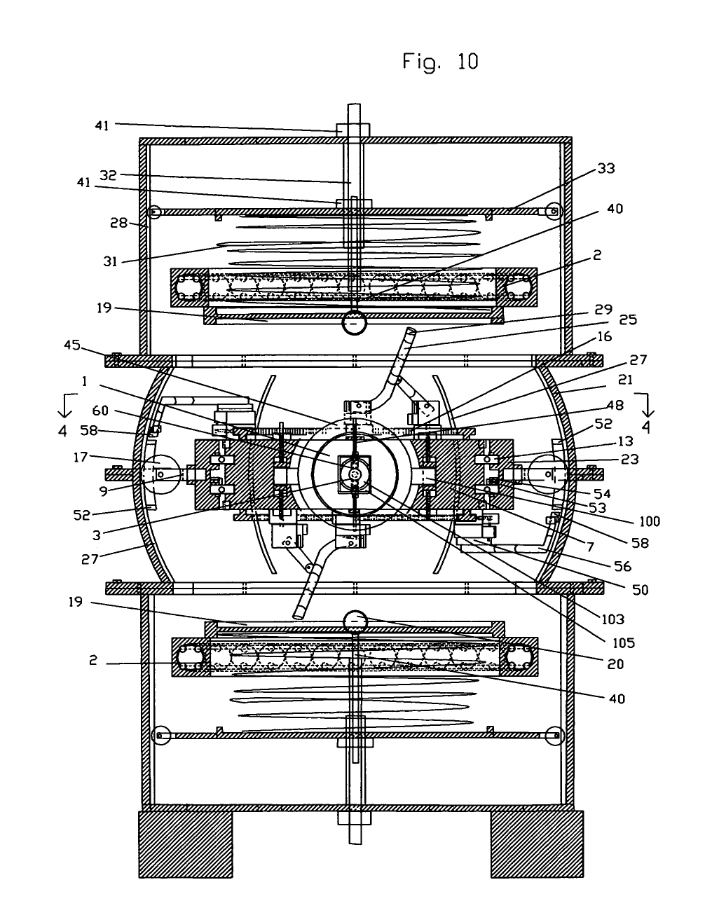

Contact between the end of the rotor axle and ring or track (54) is achieved through use of frictional contact, a wheel, or gearing (111) on the end of the axle which contacts a ring or geared track (54) located on the outer platform (23). Transmission assemblies (103) located in the inner platform along the axle allow for modification of the speed differential between the spinning rotor and the precessional rate of the precessing assembly (gyro or rotor). It also eliminates the need for dual tracks (one above and one below the axle) with transmissions designed to facilitate movement of the axle along a single track (54) by having the rotational motion of one end of the axle reversed so that driving contact can be made on to the same ring or track without inhibiting its forward motion allowing the spinning axle to move in the same precessional direction (or not in opposition to each other). This also eliminates the need for slight skewing of the tracks and eliminates the need for tilting of the generator assembly to contact two different tracks as the assembly may now be seated so that the ends of the axles already engage the track (54) prior to starting the system. The support or mount (100) is used to prevent movement of the generator/motor housing in response to rotor or armature movement by being anchored to the inner platform (7). The inner platform is also counter weighted to prevent excessive torquing in response to rotor movement when engaged in its function as a generator or motor. The use of a transmission assembly along with the ring or geared track (54) also allows for a back force to build through the system against which the spring backed plates (19) and springs (31) react so as to result in a much more effective drive system. At the same time the transmission can be used to prevent the rotor (gyro) from excessively slowing and in the case where gearing is not used help prevent the rotor axle from skating along the ring (54). Any adjustment between axle and track (54) if needed can be adjusted through use of adjustable transmission supports (105) and can be computer monitored. Naturally such need for adjustment would also require the mounting support (100) to be mounted to the inner platform in a similar manor to that of the transmissions so that adjustment can be synchronized. FIG. 10 shows such an arrangement. Elimination of this need for adjustment could be accomplished by having the inner platform and generator mated to each other in a manor such that no adjustment is needed between the end of the axle in contact with track (54) such is the case in FIG. 6. If necessary contact between the rotor axle and ring or track (54) can be monitored and adjusted through computer control and adjusting made by adjusting the rings or track, axle along with generator assembly and transmission or both.

In addition to tilting the platform (7 and 23) and rotor spin axis the telescoping of the extension arms (25) (seen in FIG. 1) also result in the spring backed and or magnetic backed plates (19) being tilted and put under pressure. This is in response to the upward (or downward—when referring to the lower half of the assembly) force exerted through the extension arms (25) due to the rotor seeking to restore itself to its original position of relative equilibrium. (As an alternative to the spring of the spring backed plate (19) & (33), opposing magnetic force fields could be utilized on plates (33) and plate (19)) This naturally would require some modification such as shielding or use of nonmagnetic materials to areas that might be affected).

To achieve a more directionally focused opposition force the spring backed plates (19) are skewed through use of weighted ball assembly (2).

The magnetic tips (29) of extension arms (25) are best seen in FIG. 2A. Magnetic plates (19) are of the same polarity as the magnetically tipped extension arms and when in operation the two magnetic components repulse each other.

The result of this arrangement is to create a vectored force acting in response or reaction to the tilted rotors force in order to augment its precessional motion.

Shielding or use of nonmagnetic materials may be necessary in areas adjacent the magnetic fields to insure proper operation. The plates (19) are magnetized on the inner surface opposite extension arms (25) and require magnetic shielding on the opposite surface (when utilized in the current design) so as not to interfere with the springs (31) and weighted ball bearing assembly (2).

Positioning of extension arms (25) and magnetic tips (29) to achieve maximum benefit is critical, hence they are designed both in their individual parts construction and in their mounting to a track (16) attached to the inner platform (7) to be movable, adjustable, pivotal and lockable through conventional means. This is best seen in FIG. 2A which shows remotely controlled servo gear drive (12) for pivoting and locking extension arms (25) and remotely controlled motor (14) for locking the base of the extension arm (25) to track (16). Remotely controlled motor or servo operated gear drive (10) can be utilized to move and lock the adjustment apparatus along track (16) via geared track (15). Extension arms (25) are also equipped with adjustable support braces (26) which are also movable on the track (16) provided on the inner platform (7) and also lockable through conventional means. An alternative is to position and lock the extension and support arms manually through trial and error through means common to the art.

Referring to FIGS. 1, 9 and 10 pressure adjustment to the magnetic plates (19) backed by springs (31) is achieved through adjustable plate (33). Both plates (33) and (19) can be further adjusted and stabilized by remotely controlled servo operated or hydraulic operated extension arms (32) and (40). Extension arm (40) connects to platform (19) through a ball bearing arrangement (20) which allows swivel movement of plate (19). Both extension arms (32) and (40) and plates (19) and (33) are used to adjust pressure or tension on the system to help regulate speed. Ball bearings or wheels (35) located on the sides of plate (33) help guide the plate along the inner wall of outer housing (21) through tracks (28) provided on the inner wall of housing (21). Hydraulic or servo motor (41) is used to power extension arms (32) and (40) in there adjustment capacity.

An alternative to the magnetic disk (19) and magnetic tipped extension arms (25) is shown in FIG. 2b. In this embodiment extension arms (25) attach to a circular ball bearing assembly (38) mounted to a non magnetic plate (37) (substitute for magnetic plate (19) in the above example), This permits motion similar to that previously discussed and illustrated in FIG. 1. The purpose of the magnets in the basic design is for the reduction of friction losses but can be replaced by the ball bearing assembly alternative just described.

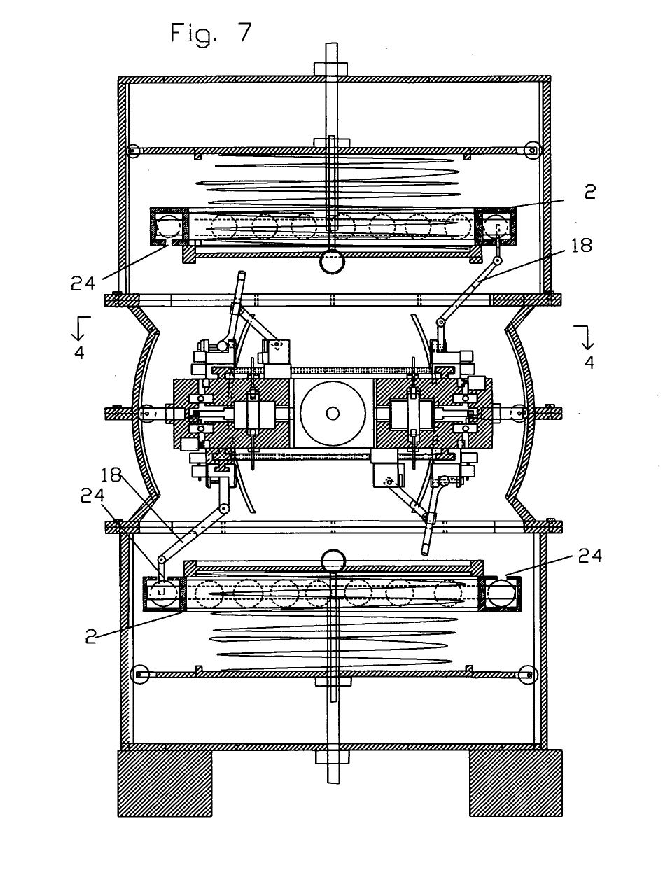

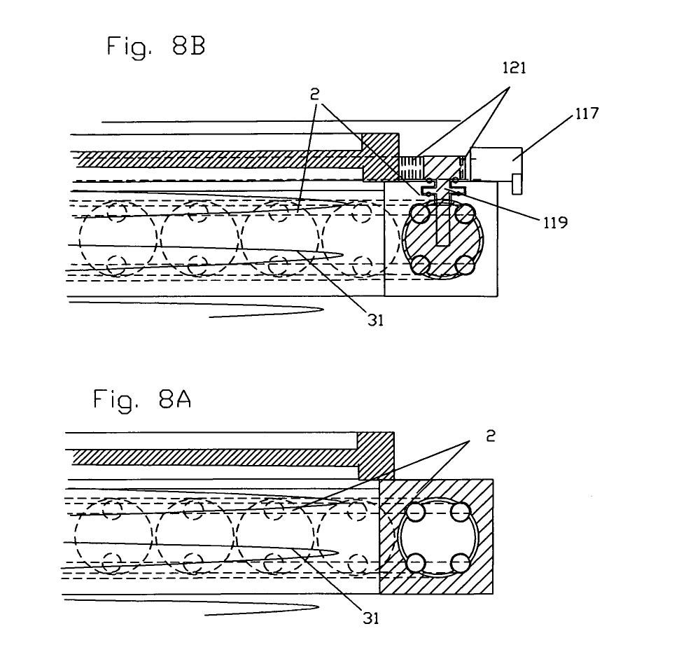

Another type of weighted rolling ball assembly (2) attaches to plate (19) as best seen in FIGS. 1, 9 and 10. The weighted balls in this assembly are designed to constantly shift with and skew the plate (19) in coordinated motion with the precessing rotor assembly. This is done to achieve greater force directed against the extension arm (25) and inner platform (7) to aid the rotors precessional motion and permits the rotor assembly to be pushed by the reactionary force. The individual balls in this assembly are individually weighted and are individually carried by ball bearings through a track (best seen in FIG. 8). Movement of the weighted balls is through gravitational force which results when platform (19) and platform (2) are offset by extension arms (25). An assisting element to the use of gravity is shown in FIG. 7 where a telescoping arm (18) is employed and is driven by either the precessional motion of the precessing assembly automatically or in combination with the motor drive assist. Here the telescoping arm (18) connects to the inner platform (7) in a fashion similar to the previously discussed extension arms (25). The other end of the arm would extend into the weighted ball assembly (2) through a channel (24) cut in the assembly. Through utilization of a ball bearing race carrying the weighted balls and a pivotal connection to the extension arm (18) the arm (18) is in a position to push behind a strategically chosen weighted ball. This would insure coordinated movement of the weighted balls and tilting of plate (19) with the precessional motion of the rotor (1) and inner platform (7). The weighting and placement of individual balls is different in each of the two assemblies (above and below the rotor) but the purpose remains the same. Weighting of these balls depends upon spring pressure, torque, and leverage. Use of a more localized motor drive is seen in FIG. 8b where a motor (117) drives a weighted assembly by means of a ball bearing mounted track (121) or drive element (119) behind a specifically weighted ball bearing to insure coordinated movement. Such a motor drive could be computer controlled and monitored by means common to the art such as computer controlled laser coordinated control.

To insure continued precessional motion of the rotor (1) and platform (7), or for initiating the drive system the platform (7) and platform (23) can utilize the motor drive (109) best seen in FIGS. 1, 2A and 4. In this capacity an electric motor (or otherwise) is used for starting and/or as an assisting agent, if needed, and is shown in some detail in FIGS. 2 and 4 where motor (109) mounted to the inner edge of the outer platform (23) engages a track (113) on the outer edge of the inner platform (7). As has been previously described, rotor axle contact with a track (54) located on the outer platform (7) insures rotational motion of the rotor and precessional motion of the rotor and inner platform. It should be noted however that other drive arrangements are possible. Some modification may be required depending upon the drive utilized as is typical of the art.

The drive system described can be used with some modification for powering a number of devices, such as a rotor of a generator, or for use as a fan among other uses. Naturally some modification such as electrical or magnetic insulation or shielding of magnetic lines of flux or for protecting against excessive heat may be required, as is understood in the art. The basic system described requires sufficient weighting of the rotor to maintain required momentum and inertia affects and counter weighting of the inner and outer platform to inhibit torque reaction to the rotating generator elements. The drawings are not to scale.

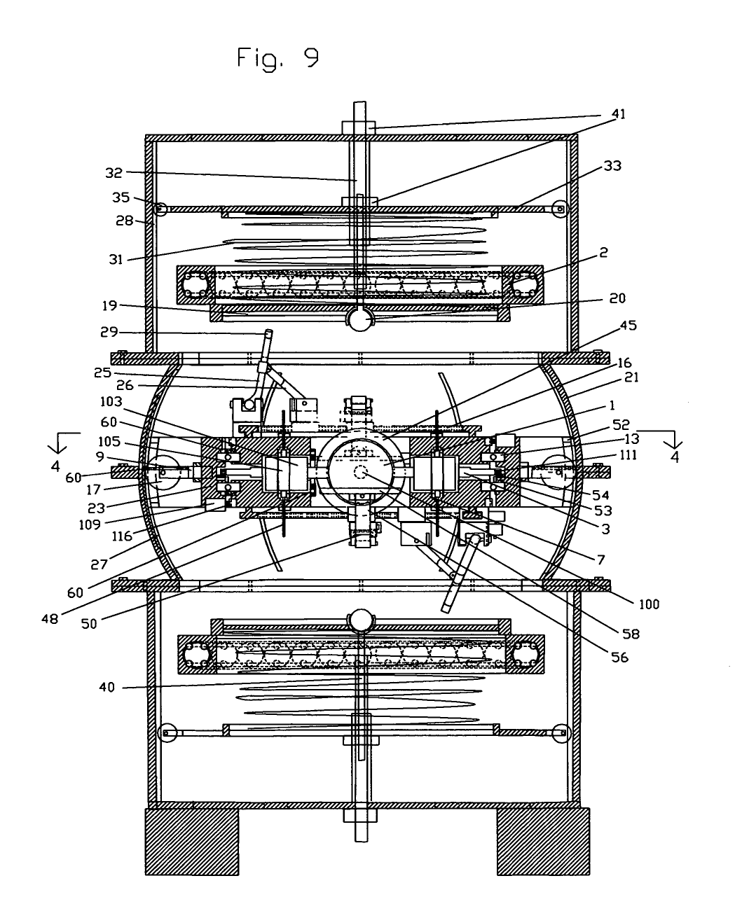

FIG. 4 is a sectional plan view of FIG. 1 or 9 taken roughly along the cutting plane 4-4. The rotor assembly shown is for a generator assembly or an electric motor which be modified for use as an electric generator by means common to the art. The gyroscopic drive principal remains as described above. First the generator rotor is brought up to operating speed by operating the generator as a motor until sufficient speed is achieved or by engaging a motor drive as previously described utilizing motor drive (109) mounted on the outer platform which engages track (116) on the inner platform this in combination the transmission (103) and rotor axle contact with track (54) results in the rotor attaining the desired speed. (shown best in FIG. 4). Once sufficient operating speed is achieved the initial drive power to the rotor may be disengaged and the extension arms (25) (shown in FIGS. 1, 9 & 10) extended. With proper placement of the telescoping remotely controlled servo operated extension arms (25) the spin axis is tilted such that precessional motion occurs. Extension of these arms also results in the weighted ball bearing assembly (2) coming in to play such that it tilts the spring backed plate (19) creating a more focused force reaction to the precessing rotor assembly. Hence the tilted precessing rotor in seeking to restore itself to its original horizontal position creates the force which is utilized to assist the precessional motion. The transmissions (103) can be engaged and controlled through remote control.

Initial or added control may be aided by use of the motor (109) and track drive (116) shown in FIG. 4. With careful adjustment of spring tension, placement of extension arms, contact of the rotor axle with its counterpart frictional element and any additional needed motor driving force (if needed), a system of high operating efficiency results.

FIGS. 9 and 10 show an example of the system utilized as a generator (generator assembly shown in generic form). In these examples the rotor would produce a torque in the stator, armature core, or generator housing (45) attached to the inner platform (7). To insure this force does not adversely affect the precessional motion of the spinning rotor the assembly can be weighted to counterbalance this effect or a restraining or stabilizing apparatus (50) can be added and employed.

One example of a stabilizing assembly can be seen best in FIGS. 9 and 10. A ledge having a magnetic quality is located on the inside wall of the outer housing. (This ledge has sections cut out of it to allow the support wheels (17) to pass through it. Remotely controlled servo operated telescoping arms (56) are attached to the inner housing in a manor similar to that of the aforementioned telescoping extension arms (25). These telescoping remotely controlled arms are equipped with rotatable, pivotal and lockable adjustable magnetic plates (58) of the same polarity as the magnetic ledge (52). When the rotor assembly is offset these plates pivot to maintain a surface parallel to the magnetic ledge. Torqueing of the inner and outer platform is hence restricted by the repulsive action between the plates (58) and the ledge (52) preventing over torqueing of the assembly in response to being run as a generator or motor. Stabilizing arms are located on either side of the inner platform and are located roughly 90 degrees or perpendicular to the rotor axle. The magnetic plates (58) need to be long enough to span the wheel tracks so as to remain effective in operation. Areas adjacent the magnetic fields (such as wheels), would need to be made of non magnetic material or insulated so as not to adversely affect operation of the system. Another alternative to the above described magnetic stabilizing apparatus (50) is to replace the spaced magnetic ledge (52) with spaced ball bearing assemblies. The aforementioned magnetic plate (58) would be replaced with a non magnetic plate which could ride within the ball bearing assembly much like the assembly shown in FIG. 2B. The connection between the telescoping extension arm and the non magnetic plate would be pivotal and lockable as previously described in the stabilizing apparatus (50). The plates here again would need to be long enough to span the gaps made by the wheel tracks (27). Placement and use of the support assembly would remain as described in the magnetic stabilizing assembly.

Electric power can be supplied to or removed from the system by convention means, brushes (60) as shown in FIGS. 4, 9 and 10.

Coordination of components can be computer controlled as is common to the art. Inertia requirements of rotor and assembly are dependent upon resistances.

Following is the formula for the period of precession

$$T = \frac{4 {π}^{2} Is}{QTs}$$

In which I is the moment of inertia and Ts the period of spin about the spin axis, and Q is the torque.

The result of this arrangement is a drive system of improved efficiency.

This system could be used with some modification, common to the art, to power a rotor for a generator, fan, or other device. The point being that the drive system described has numerous applications beyond those noted in this disclosure.

The rotor needs to be weighted for inertia purposes.

Computerized monitoring of speed and pressure control can be employed for added efficiency. Individual parts such as the support wheels may need to be made of non-magnetic materials or insulated as deemed necessary as is common to the art.

I claim:

1). Use of a transmission in combination with a rotor axle of a gyroscopic drive system which turns by virtue of axle contact with a relatively stationary track to result in the conversion or leveraging of precessional motion into high speed or high torque rotor rotation.

2). The use of a transmission as made in claim 1 by which leveraging of gyroscopic precessional motion through use of a gyros axles contact with a relatively stationary track in combination with said transmission results in a greater continuity of drive in the system.

3). The leveraging of gyroscopic precessional motion through use of a gyro or rotor axles contact with a relatively stationary track in combination with a transmission to result in high speed or high power rotor rotation.

4) The use of a transmission whereby its use in combination with a rotor axle accommodates rotor axle movement along a single relatively stationary track.

5). The use of a transmission in combination with a rotor (or gyro), rotor axle and rotor axle contact with a relatively stationary track such that a back force results in greater continuity of drive and a more controlled, efficient, and effective drive system.
